(19) United States
(12) Patent Application Publication
(10) Pub. No.: US 2007/0183386 A1
(43) Pub. Date: Aug. 9, 2007

(54) Reference Signal Sequences and Multi-User Reference Signal Sequence Allocation

(75) Inventors: Tarik Muharemovic, Dallas, TX (US); Eko Onggosanusi, Allen, TX (US); Aris Papasakellariou, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/461,982

(22) Filed: Aug. 2, 2006

Related U.S. Application Data
(60) Provisional application No. 60/705,260, filed on Aug. 3, 2005.
(60) Provisional application No. 60/789,435, filed on Apr. 5, 2006.
(60) Provisional application No. 60/762,071, filed on Jan. 25, 2006.

(51) Int. Cl. H04B 1/00; H04B 7/208

(52) U.S. Cl. 370/344; 375/150

(57) ABSTRACT

Embodiments of the invention provide method for allocating CAZAC pilot (reference signal) sequences in multiple access OFDMA systems, or alternatively, in multiple access DFT-spread OFDM(A) systems (or SC-FDMA). Reference signal transmissions from different mobiles can either be distinguished by use of disjoint sub-carriers (frequency division orthogonality), or alternatively by use of distinct cyclic shifts of one base CAZAC sequence. In a wireless cellular network, neighboring cells should utilize different CAZAC sequences, in order to mitigate out-of-cell interference.

### CLAIM OF PRIORITY UNDER 35 U.S.C. §119

The present application for patent claims priority to U.S. Provisional Application No. 60/705,260 entitled “Multi-User Pilot Sequence Allocation in OFDM systems” filed Aug. 3, 2005; U.S. Provisional Application No. 60/762,071 entitled “Increasing the Number of Orthogonal Pilot Channels” filed Jan. 25, 2006; and U.S. Provisional Application No. 60/789,435 entitled “Multi-User Pilot Sequence Allocation in OFDM systems” filed Apr. 5, 2006. All applications assigned to the assignee hereof and hereby expressly incorporated by reference herein.

### BACKGROUND

Embodiments of the invention are directed, in general, to wireless communication systems and, more specifically, to reference signal, also commonly referred to as pilot signal, sequence allocation in multi-user wireless communications systems.

FIG. 1 shows a block diagram of a transmitter 110 and a receiver 150 in a wireless communication system 100. For simplicity, transmitter 110 and receiver 150 are each equipped with a single antenna but in practice they may have two or more antennas. For the downlink (or forward link), transmitter 110 may be part of a base station (also referred to as Node B), and receiver 150 may be part of a terminal (also referred to as user equipment—UE). For the uplink (or reverse link), transmitter 110 may be part of a UE, and receiver 150 may be part of a Node B. A Node B is generally a fixed station and may also be called a base transceiver system (BTS), an access point, or some other terminology. A UE, also commonly referred to as terminal or mobile station, may be fixed or mobile and may be a wireless device, a cellular phone, a personal digital assistant (PDA), a wireless modem card, and so on.

At transmitter 110, a reference signal (also referred to as pilot signal) processor 112 generates reference signal symbols (or pilot symbols). A transmitter (TX) data processor 114 processes (e.g., encodes, interleaves, and symbol maps) traffic data and generates data symbols. As used herein, a data symbol is a modulation symbol for data, a reference signal symbol is a modulation symbol for reference signal, and the term “modulation symbol” refers to a real valued or complex valued quantity which is transmitted across the wireless link. A modulator 120 receives and multiplexes the data and reference symbols, performs modulation on the multiplexed data and reference symbols, and generates transmission symbols. A transmitter unit (TMTR) 132 processes (e.g., converts to analog, amplifies, filters, and frequency up-converts) the transmission symbols and generates a radio frequency (RF) modulated signal, which is transmitted via an antenna 134.

At receiver 150, an antenna 152 receives the RF modulated signal from transmitter 110 and provides a received signal to a receiver unit (RCVR) 154. Receiver unit 154 conditions (e.g., filters, amplifies, frequency down-converts, and digitizes) the received signal and provides input samples. A demodulator 160 performs demodulation on the input samples to obtain received symbols. Demodulator 160 provides received reference signal symbols to a channel processor 170 and provides received data symbols to a data detector 172. Channel processor 170 derives channel estimates for the wireless channel between transmitter 110 and receiver 150 and estimates of noise and estimation errors based on the received reference signal. Data detector 172 performs detection (e.g., equalization or matched filtering) on the received data symbols with the channel estimates and provides data symbol estimates, which are estimates of the data symbols sent by transmitter 110. A receiver (RX) data processor 180 processes (e.g., symbol demaps, deinterleaves, and decodes) the data symbol estimates and provides decoded data. In general, the processing at receiver 150 is complementary to the processing at transmitter 110.

Controllers/processors 140 and 190 direct the operation of various processing units at transmitter 110 and receiver 150, respectively. For example, controller processor 190 may provide demodulator 160 with a replica of the reference signal used by reference signal processor 112 in order for demodulator to perform possible correlation of the two signals. Memories 142 and 192 store program codes and data for transmitter 110 and receiver 150, respectively.

In wireless communication systems, reference signals are transmitted to serve several receiver and system purposes including channel medium estimation for coherent demodulation of the data signal at the receiver and channel quality estimation for transmission scheduling purposes. The disclosed invention is applicable to frequency division multiplexed (FDM) reference signal transmission for simultaneous transmission from multiple UEs. This includes, but is not restricted to, OFDMA, OFDM, FDMA, DFT-spread OFDM, DFT-spread OFDMA, single-carrier OFDMA (SC-OFDMA), and single-carrier OFDM (SC-OFDM) pilot transmission. The enumerated versions of FDM transmission strategies are not mutually exclusive, since, for example, single-carrier FDMA (SC-FDMA) may be realized using the DFT-spread OFDM technique. In addition, certain aspects of the invention also apply to general single-carrier systems.

FIG. 2 is an example of a block diagram showing a DFT-spread OFDM(A) transmitter (for transmission of data symbols), with “localized” sub-carrier mapping; thus, FIG. 2 is also an example of “localized” SC-OFDM(A) transmitter. It comprises of Modulated Symbols 201, serial to parallel conversion 202, Discrete Fourier Transform (DFT) block 203, Inverse Fast Fourier Transform (IFFT) block 206 Parallel to Serial (P/S) converter 207, and RF block 208. Zero padding is inserted in sub-carriers 205 (used by another UE) and 204 (guard sub-carriers), Elements of apparatus may be implemented as components in a programmable processor or Digital Signal Processor (DSP).

FIG. 3 is an example of a block diagram showing a DFT-spread OFDM(A) (bracketed letter “A” means that the statement holds for both DFT-spread OFDM and DFT-spread OFDMA) transmitter (for transmission of data symbols), with “distributed” sub-carrier mapping; thus, FIG. 3 is also an example of “distributed” SC-OFDMA transmitter. It comprises of Modulated Symbols 301, serial to parallel conversion 302, Discrete Fourier Transform (DFT) block 303, Inverse Fast Fourier Transform (IFFT) block 306 Parallel to Serial (P/S) converter 307, and RF block 308. Zero padding is inserted in sub-carriers 305 (used by another UE) and 304 (guard sub-carriers). Elements of apparatus may be implemented as components in a programmable processor or Digital Signal Processor (DSP).

Embodiments of the invention utilize a family of mathematically well studied sequences, known as CAZAC sequences, as transmitted reference signals for several purposes including coherent demodulation of the data signal and possible channel quality estimation. CAZAC sequences are defined as all complex-valued sequences with the following two properties: 1) constant amplitude (CA), implying that magnitudes of all sequence elements are mutually equal and 2) zero cyclic autocorrelation (ZAC). Well-known examples-of CAZAC sequences include (but are not limited to) Chu and Frank-Zadoff sequences (or Zadoff-Chu sequences), and generalized chirp like (GCL) sequences. There is a need to define reference signals for a wireless communication system based on previously outlined OFDM transmission schemes (such as DFT-spread OFDM, SC-OFDM, and so on) with properties selected to optimize receiver functions such as channel estimation, transmitter properties such as PAPR, and system functions such as UE scheduling.

There is another need for a way to allocate and re-use reference signal sequences among multiple UEs in the same cell of a Node B of a wireless communication system.

There is another need for a way to allocate and re-use reference signal sequences among multiple Node Bs or multiple cells of the same Node B and multiple UEs in the same cell or the same Node B of a wireless communication system.

### SUMMARY

In light of the foregoing background, embodiments of the invention provide an apparatus, method and system for generating and allocating reference signal sequences in multiple access systems. The proposed generation method for a set of reference signal sequences enables channel estimates which are nearly (or completely) free of multi-path interference as well as multiple-access interference. The disclosed invention also describes an allocation methodology for the set of reference signal sequences which enables efficient usage of corresponding sequence resources.

One embodiment of the invention is the generation and application of CAZAC sequences as reference signal sequences, for the purposes of coherent data (and/or control) signal demodulation, channel quality estimation, and other functionalities discussed herein in all frequency division multiplex (FDM) systems, which are used by multiple UEs. This includes, but is not restricted to OFDMA, OFDM, FDMA, DFT-spread OFDM, DFT-spread OFDMA, single-carrier OFDMA (SC-OFDMA), and single-carrier OFDM (SC-OFDM) reference signal transmission.

Another embodiment of the invention provides method and apparatus for allocating CAZAC sequences among multiple UEs for the purpose of reference signal transmission. This embodiment is achieved by selecting one CAZAC sequence of any length L, forming M mutually orthogonal sequences by making cyclic shifts of length Q; and allocating to at least one UE, from a plurality of UEs, a unique cyclic shift of the selected CAZAC sequence.

Another embodiment of the invention provides method and apparatus for allocating and re-using CAZAC sequences between multiple cells (and/or sectors) of a wireless cellular network. In this embodiment, any two UEs belonging to two neighboring (or near-by) cells, avoid using the same CAZAC sequence.

System and method of embodiments of the present invention solve problems identified by prior techniques and provide additional advantages.

### BRIEF DESCRIPTION OF THE DRAWINGS

Having thus described the invention in general terms, reference will now be made to the accompanying drawings, which are not necessarily drawn to scale (for example, the number of sub-carriers in FIG. 2 through FIG. 7 may be substantially larger than illustrated, such as tens, hundreds or thousands of sub-carriers), and wherein:

FIG. 1 is a diagram illustrative of an exemplary wireless communication system;

FIG. 2 is a diagram illustrative of an exemplary DFT-spread OFDM(A) transmitter with localized sub-carrier mapping, which is also referred to as an SC-FDMA transmitter;

FIG. 3 is another diagram illustrative of an exemplary DFT-spread OFDM(A) transmitter with distributed sub-carrier mapping, which is also referred to as an SC-FDMA transmitter;

FIG. 4 is a block diagram showing an apparatus for reference signal generation in accordance with an embodiment of the invention using user equipment N as an example system;

FIG. 5 is a block diagram showing an apparatus for reference signal generation in accordance with an embodiment of the invention using user equipment N+1 as an example system;

FIG. 6 is a block diagram showing an apparatus of a localized reference signal transmitter in accordance with an embodiment of the system;

FIG. 7 is a block diagram showing an apparatus of a distributed reference signal transmitter in accordance with an embodiment of the system;

FIG. 8 is a block diagram showing a first method for reference signal allocation in different cells or Node Bs of a wireless communication system in accordance with an embodiment of the system;

FIG. 9 is a block diagram showing a second method for reference signal allocation in different cells or Node Bs of a wireless communication system in accordance with an embodiment of the system; and

FIG. 10 shows a sub-frame structure extending orthogonality for more UEs in accordance with an embodiment of the invention.

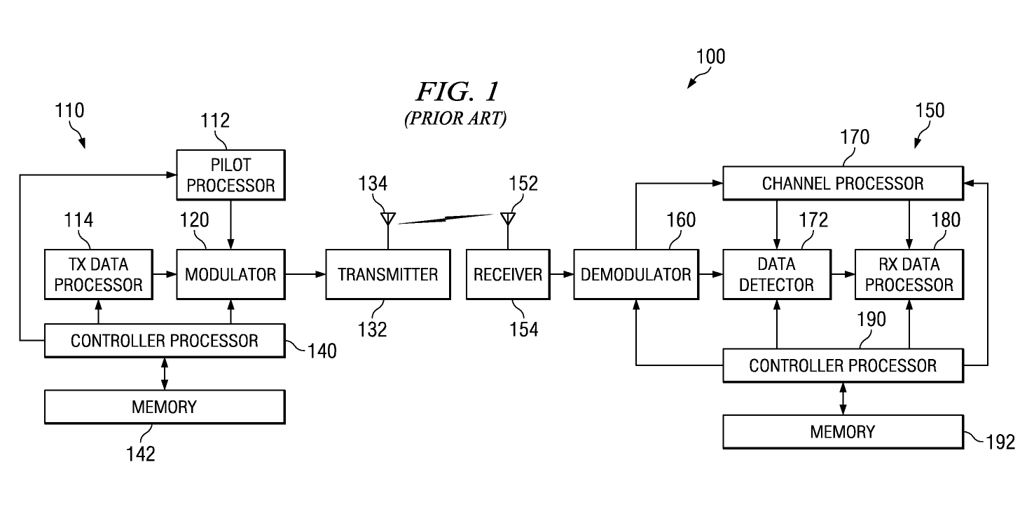

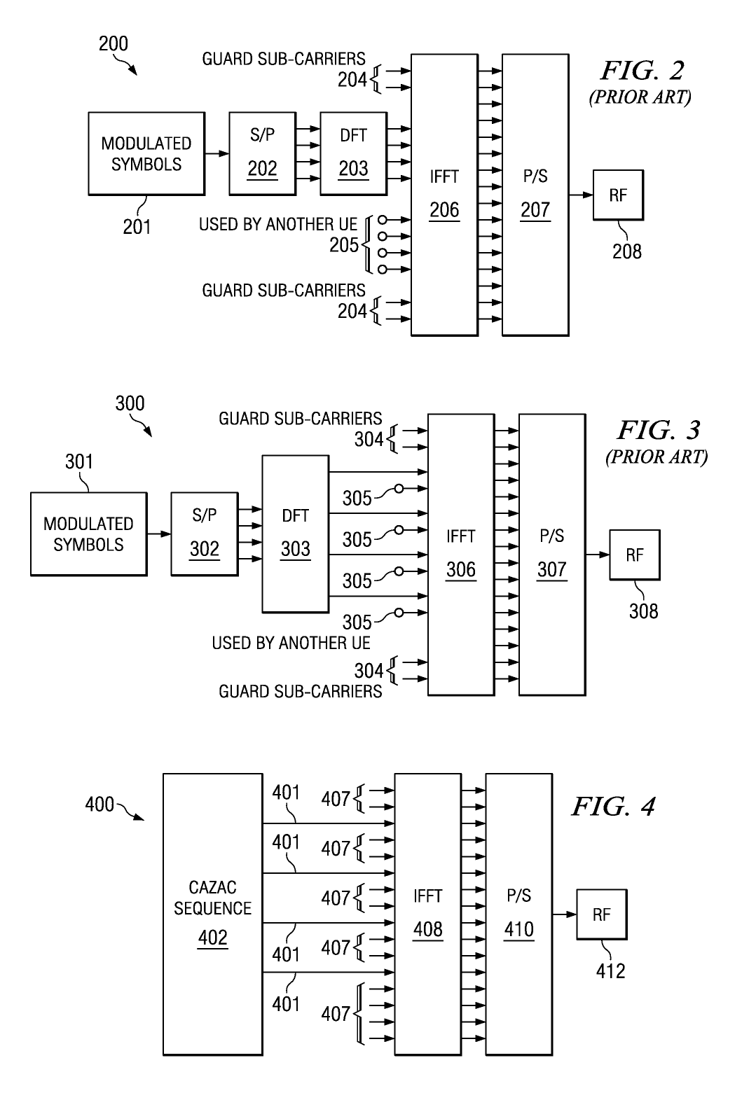

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art.

CAZAC sequences are well-described in the literature and can be found in several publications. For example, they are studied in the article by A. Milewski, “Periodic sequences with optimal properties for channel estimation and fast start-u p equalization”, IBM Journal of Research & Development, vol. 27, No. 5, September 83, pages 426-431. CAZAC sequences include a category of sequences that are polyphase sequences. See for example: L. H. Zetterberg “A class of codes for polyphases signals on a band-limited gaussian channel”, IEEE Trans. on Info. Theory, IT-11, pp 385, 1965; also see, A. J. Viterbi “On a class of polyphases codes for the coherent gaussian channel”, IEEE Int. Cony. Record, Part 7, pp 209, 1965. D. C. Chu “Polyphase Codes with Good Periodic Correlation Properties.” IEEE Trans. Info. Theory IT-18, pp. 531-532 (July 1972). CAZAC sequences also include the so-called generalized chirp like (GCL) sequences, as shown in the reference B. M. Popovic, “Generalized Chirp-like Polyphase Sequences with Optimal Correlation Properties,” IEEE Trans. Info. Theory, vol. 38, pp. 1406-1409, July 1992. See also, U.S. Pat. No. 3,008,125 by Zadoff et al.

As a specific example of a CAZAC sequences, we cite the formula for the Zadoff-Chu family of CAZAC sequences given in page 53 from K. Fazel and S. Keiser, “Multi Carrier and Spread Spectrum Systems,” John Willey and Sons, 2003. Let L be any positive integer, and let k be any number which is relatively prime with L. Also, let q be any integer. Then, according to the provided reference, the n-th entry of the k-th Zadoff-Chu CAZAC sequence is given as follows

$$\begin{matrix}{c}_{k} ( n ) = exp [ j 2 π k \frac{n ( n + 1 ) / 2 + qn}{L} ] & for L odd \\ {c}_{k} ( n ) = exp [ j2π k \frac{{n}^{2} / 2 + qn}{L} ] & for L even\end{matrix}$$

To further assist with the description of the invention, an exemplary value of q=1 is selected in the following in order to provide a more concrete description of an exemplary set of CAZAC sequences. Naturally, any other value of q would be applicable in a straightforward manner and the value of q is not material to the scope of the invention. In the following example with q=1, the CAZAC sequences are

$$\begin{matrix}{c}_{k} ( n ) = exp [ \frac{j2π k}{L} ( n + n \frac{n + 1}{2} ) ] & if L is odd \\ {c}_{k} ( n ) = exp [ \frac{j2π k}{L} ( n + \frac{{n}^{2}}{2} ) ] & if L is even\end{matrix}$$

The set of Zadoff-Chu CAZAC sequences has following desirable properties (regardless of the value of q)
Constant magnitude (or constant amplitude). This property is valid for generic CAZAC sequences, and is not specific to the Zadoff-Chu family.
Zero circular auto-correlation. This property is valid for generic CAZAC sequences, and is not specific to the Zadoff-Chu family.
Flat frequency domain response. This means that the magnitudes of each DFT entry of a CAZAC sequence are all equal. It can be shown that this property is mathematically equivalent to zero circular auto-correlation property. Thus, this property is valid for generic CAZAC sequences, and is not specific to the Zadoff-Chu family.
Circular cross-correlation between two sequences is low and with constant magnitude which is independent of the sequence offset. This property is specific to the Zadoff-Chu CAZAC sequences (with the integer q being fixed) and prime L.

From a base family of CAZAC sequences, additional CAZAC sequences can be generated using any of the following operations on each individual sequence: multiplication by a complex constant, DFT, IDFT, FFT, IFFT, cyclic shift, and block-repetition (and, at times, sequence truncation). With block-repetition, the zero cyclic auto-correlation property holds only up to a certain delay. Thus, with block-repetition, the cyclic auto-correlation is zero in the vicinity of the peak (this property is also referred to as pseudo-CAZAC). Nevertheless, the disclosed invention does not preclude the use of such pseudo-CAZAC sequences or the use of CAZAC sequences which are generated from other base CAZAC sequences.

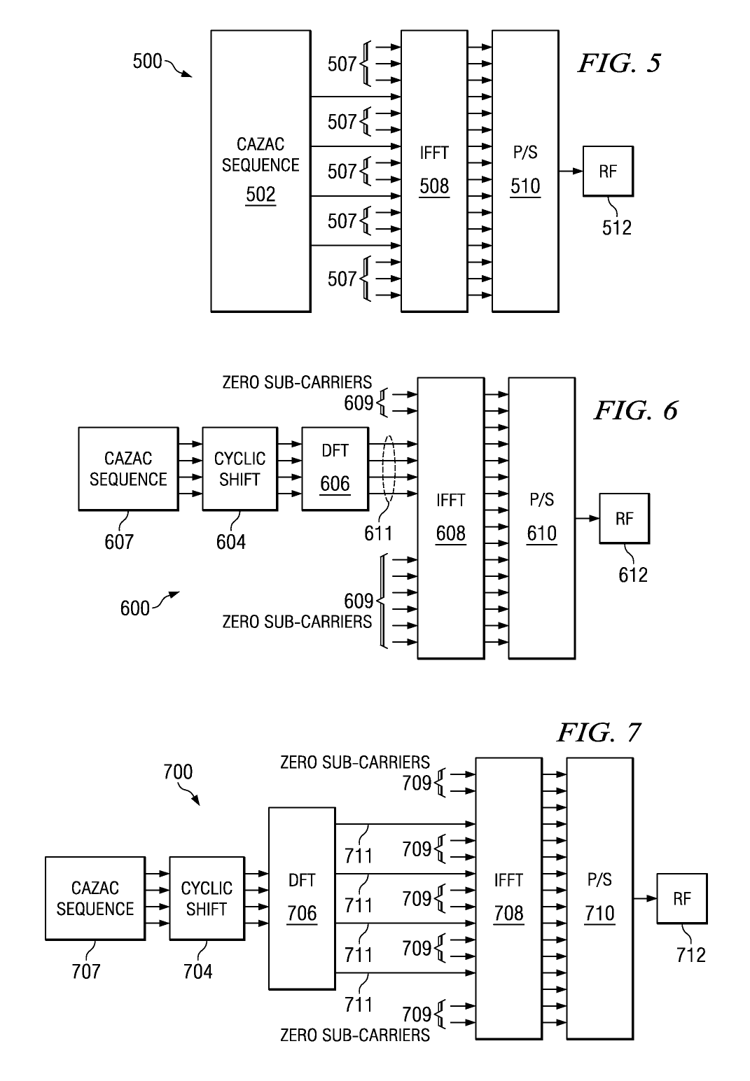

Different UEs are allowed to concurrently transmit corresponding data or reference signals. This is important in order to effectively utilize the bandwidth medium and achieve desirable aspects for the communication system such as improved throughput and decreased latency. In one embodiment of the invention, reference signals originating from different UEs (in a cell or sector) are orthogonal “in the frequency domain,” and the transmitted reference signal sequence from each UE is any CAZAC sequence (Zadoff-Chu or otherwise). Frequency domain orthogonality is achieved by allocating non-overlapping sets of sub-carriers to distinct UEs. Thus, each UE transmits a CAZAC sequence via the OFDMA transmission scheme, as shown in FIG. 4 and FIG. 5, for UE with identity N, and for UE with identity N+1, respectively (to illustrate frequency-domain orthogonality). Both FIG. 4 and FIG. 5 only convey the spirit of the transmission, and not the exact numerology as the IFFT size (408 and 508) may typically consist of tens or hundreds of sub-carriers. Furthermore, in FIG. 4 and FIG. 5 the used sub-carrier mapping (for example, arrows 411 from 402 to 408) may be arbitrary, but it is desirable that the set of sub-carriers which are used by a single UE be either contiguous, or alternatively, equally spaced. Such mapping will provide for a good peak to average power ratio (PAPR) for the time-domain signal. In addition, it is permissible that CAZAC sequences from FIG. 4 and FIG. 5 are obtained using DFT pre-processing of some original CAZAC sequences. In such case, the original CAZAC sequences are said to be transmitted using a DFT-spread OFDM(A) technique (or more specifically, SC-FDMA when all sub carriers what are used by a single UE are contiguous, or alternatively, equally spaced).

FIG. 4 is a block diagram showing an apparatus in accordance with an embodiment of the system for user equipment N for example. Apparatus 400 comprises CAZAC sequencer 402, an Inverse Fast Fourier Transform (IFFT) block 408, Parallel to Serial (P/S) converter 410, and RF block 412. Zero sub-carriers (padding) 407 are inserted at Inverse Fast Fourier Transform (IFFT) block 408. Elements of apparatus may be implemented as components in a programmable processor or Digital Signal Processor (DSP).

FIG. 5 is a block diagram showing an apparatus in accordance with an embodiment of the system for user equipment N+1 for example. Apparatus 500 comprises CAZAC sequencer 502, an Inverse Fast Fourier Transform (IFFT) block 508, Parallel to Serial (P/S) converter 510, and RF block 512. Zero sub-carriers 507 are inserted at Inverse Fast Fourier Transform (IFFT) block 508. Elements of apparatus may be implemented as components in a programmable processor or Digital Signal Processor (DSP).

In another embodiment of the invention, CAZAC reference sequences (Zadoff-Chu or otherwise), which originate from distinct UEs, are transmitted across a common (shared) pool of sub-carriers, using DFT-spread OFDM(A) transmission (or more specifically, SC-FDMA transmission). Thus, even though reference signal modulation of this embodiment is DFT-spread OFDMA, it can be said that reference signals of distinct UEs are code-division multiplexed (CDM), because they all use a shared pool of sub-carriers. In this embodiment of the invention, each CDM UE transmits a distinct cyclic shift of a base CAZAC sequence, i.e., UEs are differentiated by distinct cyclic shifts of the same CAZAC sequence. In general, for any CAZAC sequence c=[c(0) c(1) c(2) . . . c(L−1)], a corresponding cyclically shifted CAZAC sequence is Sₘ(c)=[c(m) c(m+1) c(m+2) . . . c(L−1) c(O) c(1) . . . c(m−1)], where “m” is the value of the cyclic shift. Reference signal transmitter diagram which describes this embodiment is given in FIG. 6, and is applied by each UE. It is important to note that the only distinction between transmitter diagrams of two distinct UEs is the value for the “Cyclic Shift” block 604. Thus, all UEs start with a common base CAZAC sequence 607, and the used sub-carrier mapping as illustrated by arrows 611 (606 to 608) is the same for all UEs. Thus, this problem reduces to allocating distinct values for the “Cyclic Shift” block 604 (distinct cyclic shifts) among multiple UEs. In general, this invention doesn't preclude an exhaustive use of all possible values for the “Cyclic Shift” block 604, between multiple UEs. Thus, if the original base CAZAC sequence has a length L, then a total of L distinct cyclic shifts are permissible (including zero shift), which means that a total of L UEs can be simultaneously multiplexed. In practice, only a subset of the L cyclic shifts may be used as it is determined by the time dispersion properties of the channel and possibly imperfect synchronization among UEs. With such allocation, (cyclic) cross-correlation between transmitted signals from multiple UEs is very low, or, at times, zero.

FIG. 6 is a block diagram showing an apparatus for localized reference signal (CAZAC sequence) generation in accordance with the embodiment of the system. Apparatus 600 comprises CAZAC sequencer 607, cyclic shifter 604, a Discrete Fourier Transform (DFT) block 606 and an Inverse Fast Fourier Transform (IFFT) block 608, Parallel to Serial (P/S) converter 610, and RF block 612. Used sub-carrier mapping is illustrated by arrows 611 (606 to 608). Zero sub-carriers 609 are inserted at Inverse Fast Fourier Transform (IFFT) block 608.

FIG. 7 is another block diagram showing an apparatus for distributed reference signal (CAZAC sequence) generation in accordance with the embodiment of the system. Apparatus 700 comprises CAZAC sequencer 707, cyclic shifter 704, a Discrete Fourier Transform (DFT) block 706 and an Inverse Fast Fourier Transform (IFFT) block 708, Parallel to Serial (P/S) converter 710, and RF block 712. Used sub-carrier mapping is illustrated by arrows 711 (706 to 708). Zero sub-carriers 709 are inserted at Inverse Fast Fourier Transform (IFFT) block 708.

As mentioned earlier, this invention doesn't preclude an exhaustive use of all possible values for the “Cyclic Shift” block 604 (or 704) among multiple UEs, but in practice, only a subset of cyclic shift values may be used in order to avoid loss of orthogonality due to channel time dispersion. For example, if Q is any integer, and Q<L, then the system can be restricted to use following cyclic shifts: S₀(c), S_{Q}(c), S_{2Q}(C) . . . S_{(M-1)Q}(c). This means that for one UE, the output of block 604 (or 704) is S₀(c), for another UE the output of the block 604 (or 704) is S_{Q}(c) . . . and for the M-th UE, the output of block 604 (or 704) is S_{(M-1)Q}(c). In general, it may be desirable (but not necessary) that MQ<L, while performing the above allocation of cyclic shifts between different UEs. Specific allocation of cyclic shift values among UEs may occur with Node B signaling through a control channel.

The used sub-carrier mapping 611 (606 to 608) may be arbitrary, but it is desirable that this mapping be either contiguous (“localized”), or alternatively, equally spaced (“distributed”); FIG. 6 only shows localized (while FIG. 7 shows distributed mapping from 706 to 708-arrows 711). The Zero sub-carriers 609 (or 709 for the case of “distributed”) may either be used as “guard” sub-carriers, or alternatively, they can be used to multiplex reference signals from additional UEs. When Zero sub-carriers 609 (or 709) are used to multiplex reference signals from additional UEs, this essentially amounts to frequency division multiplexing (FDM) of CAZAC sequences in different parts of the available transmission bandwidth, whereas within the same bandwidth multiplexing of CAZAC sequences occurs as previously described, and as is described in the following paragraph. Thus, in such an example, the overall reference signal multiplexing can be said to be “Hybrid.” In addition, embodiments of this invention do not preclude (in fact they recommend) that Zero Sub-Carriers 609 (or 709) be used for both “guard” sub-carriers, and for multiplexing other (additional) UEs (FDM of CAZAC sequences in different portions of the transmission bandwidth).

Based on the earlier discussion regarding a number of different methods for CAZAC sequence generation or construction, with either version of the sub-carrier mapping (localized or distributed), it is also permissible to use a pseudo-CAZAC sequence, which is obtained from an original CAZAC sequence by simple block repetition. For instance, if repetition factor (RPF) is 2, and the original CAZAC sequence is c=[c(0) c(1) c(2) . . . c(L−1)], block repetition produces [c(0) c(1) c(2) . . . c(L−1) c(0) c(1) c(2) . . . c(L−1)], when RPF=2. Other RPF factors are also permissible. Notice that CDM CAZAC sequences are only a specific case for the application of block repetition corresponding to RPF=1.

Thus, in this embodiment of the invention, reference signal transmissions from different UEs are distinguished by cyclic shifts of a common CAZAC sequence.

In the above described multiplexing strategies, it is also permissible to use more than one CAZAC sequence (for example, two sequences), with a number of distinct cyclic shifts for each sequence. For example, a primary CAZAC sequence with all M−1 cyclic shifts is used for the first M UEs, a secondary CAZAC sequence with all M−1 cyclic shifts is used for the next M UEs, a ternary sequence with all M−1 cyclic shifts is used for the next M UEs, and so on. When R CAZAC sequences are used with M shifts each, the number of supportable UEs extends to M*R (with a common pool of sub-carriers).

When a secondary CAZAC sequence is introduced in a given Node B or cell (or sector), the UEs utilizing the secondary CAZAC sequence can also apply {+1, −1} modulation across consecutive transmission periods of the reference signal. This further facilitates orthogonality between UEs which use the primary and the secondary CAZAC code by doubling the number of orthogonal codes available to the UEs in each Node B or cell. For instance, we now refer to FIG. 10, which shows EUTRA sub-frame structure extending orthogonality for more UEs in accordance with an embodiment of the invention. Sub-frame structure 1000 comprises of long blocks (LB) 1002, and cyclic prefixes (CP) 1006. The sub-frame of structure 1000 also has two short blocks (SB1) 1004A and (SB2) 1004B, which are dedicated for transmission of the reference signal (CAZAC sequence). Thus, UEs which utilize the secondary CAZAC sequence can also modulate (multiply by −1) the transmission of the reference signal in SB2. This also applies to both SC-FDMA and OFDMA reference signal transmission. Note that multiplication by a constant doesn't violate any of the CAZAC properties.

Thus, when a secondary CAZAC sequence is introduced in a given Node B or cell (or sector), both SB1 and SB2 can be used to provide orthogonality. Suppose two UEs (UE 1 uses primary and UE 2 uses secondary CAZAC) are non-orthogonal within SB1 and SB2 individually. UE 1 modulates SB1 and SB2 with one CAZAC sequence. UE 2 modulates SB2 as −SB1 (opposite sign in SB1 and SB2). UE 2 may have the same or different sequence as UE 1 and UE 2 may have the same or different cyclic shift as UE 1. Thus, when SB 1 and SB 2 are considered jointly, UE 1 and UE 2 are orthogonal (even though they may not necessarily be orthogonal in either SB1 or SB2 separately), and consequently UEs which employ primary and secondary CAZAC sequences are orthogonal.

Naturally, discussion in the above two paragraphs assumes that the channel does not change substantially in the time period between SB1 and SB2 so that orthogonality can be maintained. This can be determined by the assigning Node B though estimation of the Doppler shift of the UEs scheduled in a particular sub-frame. If all those UEs have velocities (or equivalently Doppler shifts) that do not lead to substantial channel variations in the time period between SB1 and SB2, the Node B scheduler may double the number of UEs in a sub-frame that can transmit reference signals (CAZAC sequences) having the desirable CAZAC properties as described in FIG. 10. Otherwise, the corresponding multiplexing method (which uses both SB1 and SB2) may not apply.

In a wireless cellular system, special design considerations must be dedicated to “co-channel interference,” which is also known as “out-of-cell interference.” The bulk of the out-of-cell interference comes from geographically neighboring cells (which are also called the “first-tier” cells), but also from the near-by “second-tier” cells, and from the near-by “third-tier” cells.

Thus, in another embodiment of this invention, transmission of reference signals in a wireless cellular system is such that two UEs from neighboring cells use different CAZAC sequences (during any given interval which is designated for transmission of reference signals). To accomplish this objective, a cellular network should avoid scenarios where two UEs from neighboring cells perform concurrent transmission of a given CAZAC sequence, on any given set of sub-carriers, at any given time (a common time-frequency resource). This is applicable irrespective of whether transmission of the reference signal is SC-FDMA or OFDMA, and irrespective of the multiplexing strategy for reference signals. Such design practice can be achieved in a static manner by geographical cell planning and CAZAC sequence re-use, but non-static approaches involving communication among adjacent cells (or sectors) regarding the use CAZAC sequences used in each cell (or sector) may also apply to address variations in traffic in adjacent cells (or sectors). Other alternative methods are not precluded. The following examples of this embodiment apply to transmission of reference signal on a common time-frequency resource.

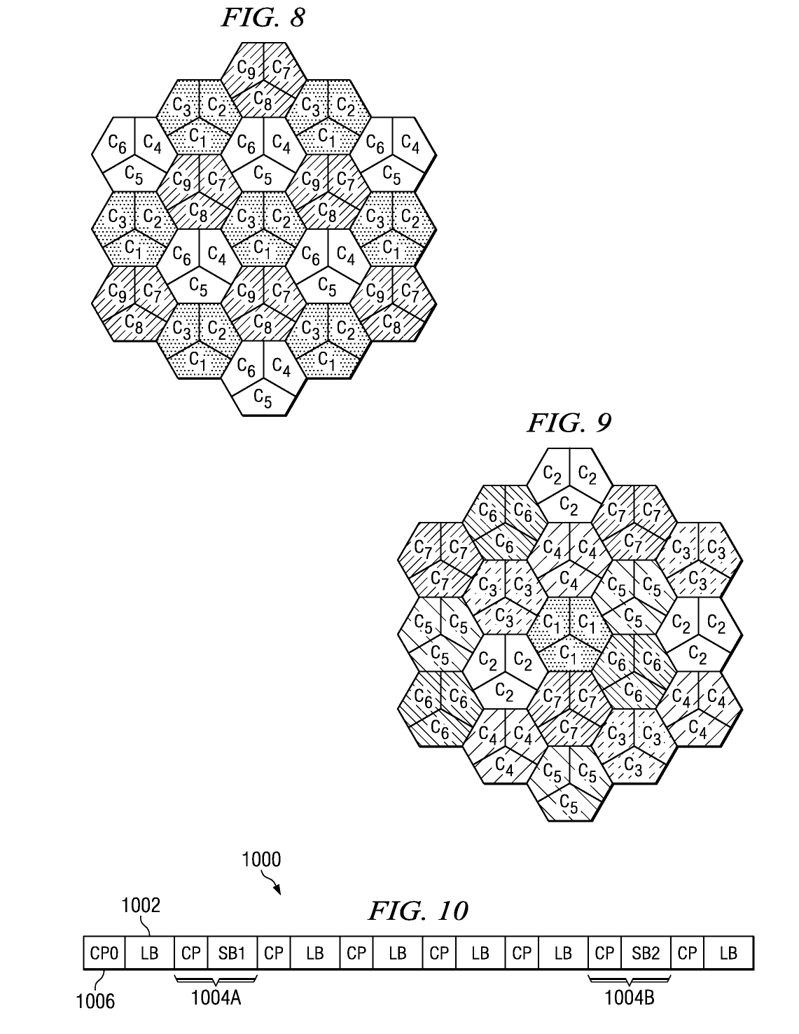

In one example of this embodiment, all sectors (or cells) of any given Node B are treated as separate ones. Thus, in this example, the cellular network is designed to avoid the scenario where two UEs from neighboring sectors (same or different cell) perform transmission of the same CAZAC reference signal sequence across a common time-frequency resource. Such co-ordination can be achieved either through signaling of the utilized CAZAC sequences among Node Bs in a corresponding set of Node Bs (for example one Node B may inform another one of a particular CAZAC sequence usage) or through signaling among such Node Bs and a central node performing the co-ordination (for example, a central node co-ordinates the CAZAC sequence assignment to each Node B in a set of Node Bs so that any two Node Bs in the set of Node Bs do not employ the same CAZAC sequence), or other methods (such as static sequence planning among adjacent cells, for example). For instance, the cellular network can use Zadoff-Chu CAZAC sequences (with fixed q), and the index of the Zadoff-Chu CAZAC sequence (the value for “k” in the Zadoff-Chu formula) can vary across neighboring sectors, as shown in FIG. 8. As an example only, FIG. 8 shows 9 codes (C₁ to C₉) with three codes assigned to any cell (C₁, C₂, C₃); (C₄, C₅, C₆); (C₇, C₈, C₉) with different shading respectively. Thus, FIG. 8 portrays the use of Zadoff-Chu CAZAC sequences in the wireless cellular network (with 19 cells shown), and with three sectors per cell. FIG. 8 is only exemplary because it shows sectorized sequence re-use, with re-use factor 9. Other, larger or smaller, re-use factors are also possible. This, of course, holds for any given time-frequency resource, since the out-of-cell interference is irrelevant otherwise.

In another example of this embodiment, different sectors of a given Node B are not treated as separate neighboring cells. Thus, in this example, it is permissible that two UEs, which belong to two different sectors of the same Node B (or cell), use a common CAZAC sequence (with a common cyclic shift) for transmission of the reference signal (across a common time-frequency resource). In this case, reference signals from different UEs are separated by sectorization. Nevertheless, in this example, the cellular network is still designed to avoid the scenario where two UEs from neighboring sectors of a different cell perform transmission of the same CAZAC sequence across a common time-frequency resource. For instance, the cellular network can use Zadoff-Chu CAZAC sequences (with fixed q), and the index of the Zadoff-Chu CAZAC sequence (the value for “k” in the Zadoff-Chu formula) can vary across neighboring sectors (of different cells), as shown in FIG. 9. Thus, FIG. 9 portrays the use of Zadoff-Chu CAZAC sequences in the wireless cellular network (with 19 cells plotted), and with three sectors per cell. FIG. 9 is only exemplary because it shows cell-wise sequence re-use, with re-use factor 7. Other, larger or smaller, re-use factors are also possible. This, of course, holds for any given time-frequency resource, since the out-of-cell interference is irrelevant otherwise.

Many other modifications and other embodiments of the invention will come to mind to one skilled in the art to which this invention pertains having the benefit of the teachings presented in the foregoing descriptions, the associated drawings, and claims. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

All herein described reference signal transmissions may (or may not) be preceded by a “cyclic prefix,” which is a common practice in all frequency division multiplex systems (FDM). These systems include, but are not restricted to, OFDM, OFDMA, FDMA, DFT-spread OFDM, DFT-spread OFDMA, single-carrier OFDMA (SC-OFDMA), and single-carrier OFDM (SC-OFDM) pilot transmission. Transmission (or non-transmission) of the “cyclic prefix” doesn't affect the scope of the invention.

All herein described reference signal transmissions (or parts of them) may be pre-computed, stored in the memory of the UE device, and used when necessary. Any such operation (pre-computing and storage) does not limit the scope of the invention.

The exemplary embodiment of the invention assumes that the reference signal is time division multiplexed (TDM) with the data and/or control signal (from a single UE), that is, transmission of the reference signal does not occur concurrently with the data and/or control signal. This assumption only serves to simplify the description of the invention, and is not mandatory to the invention. Nevertheless, when the reference signal is TDM multiplexed with the data signal, the two can use different modulation. For instance, data signal can use SC-OFDM(A), while the reference signal can use OFDMA multiplexing, as in FIG. 4 and FIG. 5.

In case of multi-antenna transmission, multiple antennas of a singe UE can be treated as different UEs, for the purpose of allocating reference signals. All herein described designs extend in a straightforward manner to the case of multi-antenna transmission.

All herein described multi-user allocations can be trivially reduced and also applied to the single-user scenario.

What is claimed is:

1. An apparatus for forming a signal in single-carrier frequency division multiple access (SC-FDMA) transmission system, said apparatus comprising:
Constant Amplitude Zero Auto-Correlation (CAZAC) sequencer creating at least one CAZAC sequence; and
transmitter for transmitting said at least one CAZAC sequence in accordance with the single-carrier frequency division multiple access (SC-FDMA) transmission method.

2. The apparatus as in claim 1, wherein said at least one CAZAC sequence serves as a reference signal in SC-FDMA communication systems.

3. The apparatus as in claim 1, wherein said at least one CAZAC sequence is a Zadoff-Chu sequence.

4. An apparatus for forming a signal in single-carrier frequency division multiple access (SC-FDMA) transmission system, said apparatus comprising:
Constant Amplitude Zero Auto-Correlation (CAZAC) sequencer creating at least a first CAZAC sequence;
receiver for receiving at least a second CAZAC sequence; and
processor configured to process said at least second CAZAC sequence with said at least first CAZAC sequence.

5. The apparatus as in claim 4, wherein said at least first CAZAC sequence is created at a Node B and at least said second CAZAC sequence is transmitted by a user equipment.

6. The apparatus as in claim 4, wherein said processing creates a channel estimate for a SC-FDMA signal transmitted by a user equipment.

7. The apparatus as in claim 4, wherein said processing creates a channel quality indication (CQI) estimate for a SC-FDMA signal transmitted by a user equipment.

8. An apparatus in a communication link, said comprising:
Constant Amplitude Zero Auto-Correlation (CAZAC) sequencer creating at least one CAZAC sequence;
cyclic shifter for forming a plurality M mutually orthogonal sequences through M−1 cyclic shifts of said at least one CAZAC sequence; and
allocator for allocating to at least one user equipment, from a plurality of user equipments, at least one shift of said M−1 cyclic shifts of said at least one CAZAC sequence.

9. The apparatus as in claim 8, wherein said at least one shift of said M−1 cyclic shifts of said at least one CAZAC sequence is signaled to said user equipment by a Node B serving the communication link.

10. The apparatus as in claim 8, wherein said at least one CAZAC sequence is signaled to said user equipment by a Node B serving the communication link.

11. An apparatus comprising:
Constant Amplitude Zero Auto-Correlation (CAZAC) sequencer creating at least one CAZAC sequence;
cyclic shifter for forming at least one of M mutually orthogonal CAZAC sequences; and
selector for selecting at least one of said at least one of M mutually CAZAC orthogonal sequences for transmission with a single-carrier frequency division multiple access (SC-FDMA) communication method.

12. The apparatus as in claim 11, wherein said selecting is made by a user equipment.

13. The apparatus as in claim 11, wherein said selected CAZAC sequence serves as a reference signal.

14. The apparatus as in claim 11, wherein said selection is based on signaling from a Node B having a communication link with said user equipment.

15. A method for allocating at least one CAZAC sequence to a plurality of user equipments in a communication system, said method comprising:
selecting a CAZAC sequence of length L;
forming M mutually orthogonal CAZAC sequences through M−1 cyclic shifts of length Q of said CAZAC sequence of length L; and
allocating to at least one user equipment, from said plurality of user equipments, at least one shift of said M−1 cyclic shifts of said CAZAC sequence of length L.

16. The method as in claim 15, wherein said plurality of user equipments are located in different sectors or cells of a Node B.

17. The method as in claim 15, wherein distinct CAZAC sequences are allocated to neighboring Node Bs.

18. The method as in claim 15, 16, or 17, wherein said CAZAC sequences are Zadoff-Chu sequences.

19. The method as in claim 15, 16, or 17, wherein the communication system is an SC-FDMA system.

20. The method as in claim 15, wherein each of said different sectors or cells of said Node B contain a plurality of distinct cyclic shifts.

21. The method as in claim 20, wherein some of said plurality of said M−1 cyclic shifts are re-used by user equipments among said different sectors or cells of said Node B.

22. A method for coordinating the assignment of a CAZAC sequence in each Node B in a set of Node Bs, said method comprising:
selecting a CAZAC sequence in at least one Node B in said set of Node Bs; and
signaling said selected CAZAC sequence by said at least one Node B in said set of Node Bs to remaining Node Bs in said set of Node Bs.

23. The method as in claim 22, wherein said remaining Node Bs in said set of Node Bs avoid the selection of said CAZAC sequence.

24. A method for coordinating the assignment of a CAZAC sequence in each Node B is a set of Node Bs, said method comprising:
selecting a CAZAC sequence in at least one Node B in said set of Node Bs in response to signaling from a central Node for said set of Node Bs.

25. A method for coordinating in each Node B in a set of Node Bs the allocation of CAZAC sequences to a plurality of user equipments in said each Node B in a set of Node Bs, said method comprising:
selecting a set of mutually orthogonal CAZAC sequences; and
assigning each CAZAC sequence from said set of mutually orthogonal CAZAC sequences to each said Node B in a set of Node Bs.

26. A computer-readable medium bearing instructions for allocating multi-user CAZAC sequences in a communication system, said instructions being arranged upon execution, to cause one or more processors to perform the method of claim 15, 22, 24, or 25.

27. A method for allocating a CAZAC sequence to a plurality of user equipments in a communication system, for transmission over at least two consecutive time periods, said method comprising:
selecting a CAZAC sequence of length L;
allocating to a first user equipment from said plurality of user equipments, said selected CAZAC sequence for transmission in said at least two consecutive time periods;
allocating to a second user equipment, from said plurality of user equipments, said selected CAZAC sequence for transmission in a first of said at least two consecutive time periods; and
allocating to said second user equipment the algebraic opposite (negative) of said selected CAZAC sequence for transmission in a second of said at least two consecutive time periods.

28. The method of claim 27, wherein a user equipment transmission uses said selected CAZAC sequence in said second of said at least two consecutive time periods and uses said opposite (negative) of said CAZAC sequence in said first of said at least two consecutive time periods.

29. A method for allocating at least two CAZAC sequences to a plurality of user equipments in a communication system, for transmission over at least two consecutive time periods, said method comprising:
selecting a CAZAC sequence of length L;
forming at least two mutually orthogonal CAZAC sequences by making cyclic shifts of length Q for said selected CAZAC sequence of length L;
allocating to a first user equipment, from said plurality of user equipments, a first of said at least two mutually orthogonal CAZAC sequences for transmission in said at least two consecutive time periods; and
allocating to a second user equipment, from said plurality of user equipments, a second of said at least two mutually orthogonal CAZAC sequences for transmission in a first of said at least two consecutive time periods and for transmission of the algebraic opposite (negative) of said second of said at least two mutually orthogonal CAZAC sequences in a second of said at least two consecutive transmission periods.

30. The method of claim 29, wherein a user equipment transmission uses said second of said at least two mutually orthogonal CAZAC sequences in said second of said at least two consecutive time periods and uses said algebraic opposite (negative) of said second of said at least two mutually orthogonal CAZAC sequences in said first of said at least two consecutive time periods.

31. A method for transmitting during at least two consecutive transmission time periods a CAZAC sequence at a user equipment in a communication system, said method comprising:
transmitting said CAZAC sequence in a first of said at least two consecutive transmission time periods;
transmitting the algebraic opposite (negative) of said CAZAC sequence in a second of said at least two consecutive transmission time periods.

32. The method of claim 31, wherein said algebraic opposite (negative) of said CAZAC sequence is transmitted in said first of said at least two consecutive transmission time periods and said CAZAC sequence is transmitted in said second of said at least two consecutive transmission time periods.

33. A method for multiplexing two CAZAC sequences allocated to a first and second user equipments in a communication system, said communication system having a transmission bandwidth, said method comprising:
selecting a first CAZAC sequence of length L1;
allocating said first CAZAC sequence to said first user equipment for transmission into a first portion of said bandwidth selecting a second CAZAC sequence of length L2; and
allocating said second CAZAC sequence to said second user equipment for transmission into a second portion of said bandwidth;
wherein said transmission of said first CAZAC sequence and said transmission of said second CAZAC sequence do not occupy any common sub-carriers in any of said portions of said transmission bandwidth.

34. A method for creating a reference signal for communication from a user equipment to a Node B, wherein said reference signal is constructed from a CAZAC sequence, said method comprising;
constructing a CAZAC sequence;
mapping said CAZAC sequence to used sub-carriers;
inserting zeros for the unused sub-carriers; and
performing the IFFT operation on all sub-carriers.

35. The method of claim 34 wherein said mapping of used sub-carriers is equally spaced.

36. The method of claim 34 wherein said mapping of used sub-carriers is contiguous.

37. The method of claim 34, 35, or 36, wherein said reference signal is a SC-FDMA signal.

38. The method of claim 34, 35 or 36, wherein said reference signal is an OFDMA signal.

39. The method of claim 34, 35, or 36, wherein said reference signal is a DFT-spread OFDMA signal.

40. The method of claim 34, wherein said CAZAC sequence is constructed by:
creating a base CAZAC sequence;
performing a cyclic shift operation on said base CAZAC sequence; and
performing the DFT operation.

41. A frame structure, said structure comprising;
a plurality of long blocks containing data; and
a plurality of short blocks containing reference signals constructed from at least one CAZAC sequence.

42. The frame structure of claim 41, wherein first of said plurality of short blocks is distributed and second of said plurality of short blocks is localized.

43. A method for multiplexing CAZAC reference signals from at least two users equipments (UEs), said method comprising;
determining at least one used sub-carrier mapping for each of said at least two UEs;
signaling said at least one used sub-carrier mapping to each of said at least two UEs; and
receiving the multiplexed transmissions from each of said at least two UEs.

44. A method for multiplexing CAZAC reference signals from at least two user equipments (UEs), said method comprising:
determining at least one cyclic shift for each of said at least two UEs;
signaling said at least one cyclic shift to each of said at least two UEs; and
receiving the multiplexed transmissions from each of said at least two UEs.

45. A method for combined hybrid multiplexing of CAZAC reference signals from at least two user equipments (UEs), said method comprising:
determining at least one used sub-carrier mapping for each of said at least two UEs;
determining at least one cyclic shift for each of said at least two UEs;
signaling the used sub-carrier mapping to each of said at least two UEs;
signaling said at least one cyclic shift to each of said at least two UEs; and
receiving the multiplexed transmissions from each of said at least two UEs.

46. The method as in claim 43, 44, or 45, wherein distinct CAZAC sequences are allocated to neighboring sectors.

47. The method as in claim 43, 44, or 45, wherein distinct CAZAC sequences are allocated to neighboring cells.

48. The method as in claim 43, 44, or 45, wherein distinct CAZAC sequences are Zadoff-Chu CAZAC sequences.
